(19) United States
(12) Patent Application Publication
(10) Pub. No.: US 2006/0171544 A1
(43) Pub. Date: Aug. 3, 2006

(54) Wireless low-frequency audio reproduction system for an electronic device

(76) Inventor: Show-Nan Chung, Taipei (TW)

Correspondence Address: RABIN & Berdo, PC, 1101 14TH STREET, NW, SUITE 500, WASHINGTON, DC, 20005, US

(21) Appl. No.: 11/339,789

(22) Filed: Jan. 26, 2006

(30) Foreign Application Priority Data
Feb. 1, 2005 (TW) 94103130
Feb. 6, 2005 (CN) 200510008143.8

(51) Int. Cl. H04B 3/00; H04B 5/00

(52) U.S. Cl. 381/77; 381/79

(57) ABSTRACT

A wireless low-frequency audio reproduction system for an electronic device. The wireless low-frequency audio system reproduces sound in response to a source audio signal of the electronic device and includes an audio processing device, a wireless transmission module, and an audio reproduction device. The audio reproduction device includes a low-frequency speaker, wireless transmission module, and amplifier. The audio processing device is for producing a low-frequency audio signal according to the source audio signal. The wireless transmission module wirelessly transmits the low-frequency audio signal. The wireless receiving module is for wirelessly receiving and outputting the low-frequency audio signal. The amplifier is used for driving the low-frequency speaker to reproduce sound according to the low-frequency audio signal from the wireless receiving module.

This application claims the benefit of Taiwan application Ser. No. 94103130, filed Feb. 1, 2005, the subject matter of which is incorporated herein by reference.

### BACKGROUND OF THE INVENTION

1. Field of the Invention

The invention relates in general to a wireless audio system, and more particularly to a wireless low-frequency audio system for an electronic device.

2. Description of the Related Art

A conventional television set produces a source audio signal and typically includes two speakers for reproducing left and right channels of stereophonic sound according to the source audio signal. Unfortunately, these built-in speakers have worse performance in reproducing low frequencies, such as bass sound. In order to prevent the two speakers from making noise due to weakness in reproducing low frequencies, an audio processing device in the television set conventionally filters out low frequency components of the source audio signal produced by the television set.

Hence, with such a design limitation, the television set could not reproduce low frequencies through its built-in speakers even if it displays a video or television program with full-range sound effects. In particular, users cannot experience woofer or subwoofer sounds when watching a movie with subwoofer sounds, sounds of engines for example. Therefore, the users who would like to enjoy that woofer or subwoofer sound effects have to additionally purchase an audio system as well as a number of audio cables for connection between the audio system and additional speakers to reproduce the effects. Such approach to the enjoyment of sound effects is complex and the system together with the cables and speakers occupies users' space, not only spending much more money but also making inconvenience in installation and use.

### SUMMARY OF THE INVENTION

An object of the invention is to provide a wireless low-frequency audio system for an electronic device in order to solve the deficiency of a conventional television set, which cannot reproduce the bass sound effects. The wireless low-frequency audio system transmits a low-frequency portion of a source audio signal produced by the electronic device to a low-frequency speaker wirelessly, thus providing flexibility in locating the low-frequency speaker.

According to an embodiment of the invention, a wireless low-frequency audio system for an electronic device is provided. The electronic device is an audio-video reproduction system including an audio-video reproduction device and an audio reproduction device. The wireless low-frequency audio system reproduces sound in response to a source audio signal of the audio-video reproduction system. The wireless low-frequency audio system includes an audio processing device, a wireless transmission module, and the audio reproduction device. The audio processing device and wireless transmission module are disposed in the audio-video reproduction device. The audio reproduction device includes a low-frequency speaker, a wireless receiving module, and an amplifier.

The audio processing device is for producing a signal representing a low-frequency portion of the source audio signal according to the source audio signal. The wireless transmission module wirelessly transmits a wireless signal according to the signal representing the low-frequency portion of the source audio signal. The wireless receiving module is for wirelessly receiving the wireless signal and producing a low-frequency audio signal according to the wireless signal. The amplifier is used for driving the low-frequency speaker to reproduce sound according to the low-frequency audio signal from the wireless receiving module.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates an electronic device according to a preferred embodiment of the invention.

FIG. 2 is a block diagram illustrating the wireless low-frequency audio system for the electronic device illustrated in FIG. 1 according to the preferred embodiment of the invention.

### DETAILED DESCRIPTION OF THE INVENTION

In accordance with the invention, a wireless low-frequency audio system for an electronic device wirelessly transmits a low frequency portion of a source audio signal of the electronic device, i.e. low-frequency audio components, all or in part, of the source audio signal, to a low-frequency speaker. In this way, locating of the low-frequency speaker becomes more flexible, without the inconvenience of using connecting audio cables, as the conventional approach requires.

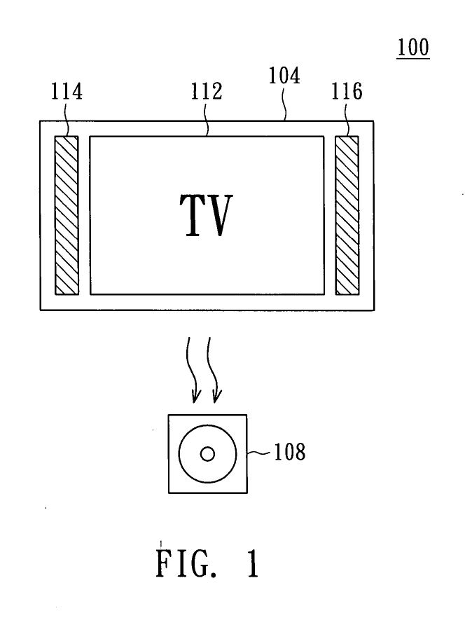

FIG. 1 illustrates an electronic device according to a preferred embodiment of the invention. The electronic device 100 is an audio-video reproduction system, for example. The audio-video reproduction system 100 includes an audio-video reproduction device 104 and an audio reproduction device 108. The audio-video reproduction device 104 is a device or system that can display video and audio. The audio-video reproduction device 104 shown in FIG. 1 is a television set according to this embodiment, wherein the television set can be a liquid crystal display television set, a plasma television set, or a cathode ray tube television set. In another embodiment, the audio-video reproduction device 104 can be a computer system, such as a desktop computer, a notebook computer, or a barebone computer system. The audio reproduction device 108 wirelessly links to the audio-video reproduction device 104 and wireless signals are transmitted between them.

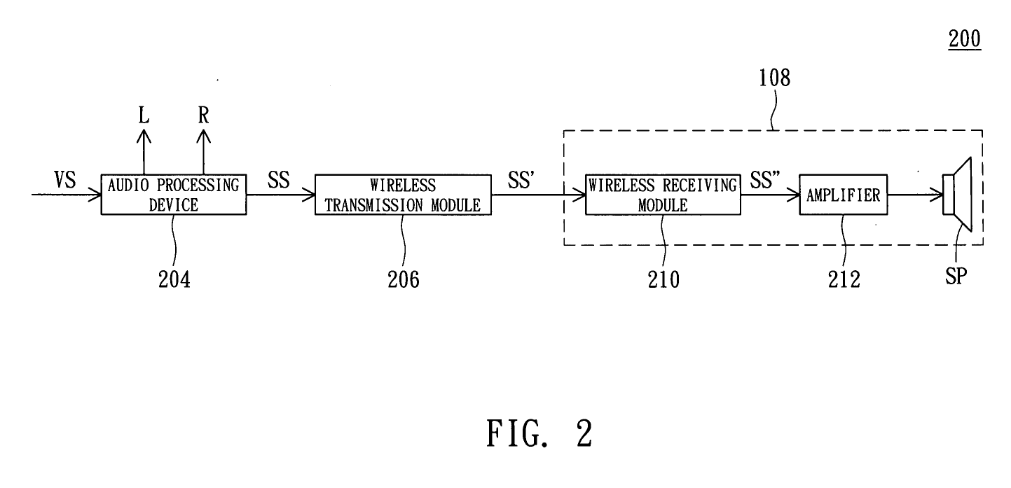

Referring to FIG. 2, a wireless low-frequency audio system for the audio-video reproduction system 100 is shown in block diagram form. The wireless low-frequency audio system 200 includes an audio processing device 204, a wireless transmission module 206, and the audio reproduction device 108. The audio processing device 204 and the wireless transmission module 206 are disposed in the audio-video reproduction device 104. The audio reproduction device 108 includes a low-frequency speaker SP, a wireless receiving module 210, and an amplifier 212.

In this embodiment, the audio-video reproduction device 104 is a television set which displays a video according to a media signal VS representing video and audio of, for example, a broadcasting television program or a movie from a digital video disk or video compact disk. In response to the media signal VS, the audio processing device 204 of the audio-video reproduction device 104 outputs a low-frequency audio signal SS, and audio signals for multi-channel stereophonic sound according to a source audio signal obtained from the media signal VS, for example, a left-channel audio signal L and a right-channel audio signal R. The audio signal L and R represent frequency components greater than about a specific frequency, e.g. 180 Hz, of the left and the right channels of stereophonic sound, respectively, according to the source audio signal. In addition to the audio signals L and R, the audio processing device 204 outputs the low-frequency audio signal SS, representing low frequency components less than about a specific frequency, e.g. 180 Hz, according to the source audio signal. The audio processing device 204 utilizes, for example, a high-pass filter and a low-pass filter, or an equalizer, to separate the audio frequency components from the source audio signal into the left-and right-channel audio signals L and R and the low-frequency audio signal SS. The left and right speakers of the television set, as illustrated by the speakers 114 and 116 in FIG. 1, produce sound corresponding to the left-and right-channel audio signals L and R. By contrast, the audio processing device 204 outputs the low-frequency audio signal SS to the wireless transmission module 206.

The wireless transmission module 206 converts the low-frequency audio signal SS into a wireless signal SS′ according to the information of the low-frequency audio signal SS, and wirelessly transmits the wireless signal SS′ to the audio reproduction device 108. The wireless receiving module 210 of the audio reproduction device 108 wirelessly receives the wireless signal SS′ and produces a low-frequency audio signal SS″ according to the wireless signal SS′ received. In one embodiment, the wireless receiving module 210 converts the received wireless signal SS′ into the low-frequency audio signal SS″ in an analog form through digital-to-analog conversion. The low-frequency audio signal SS″ is then fed into the amplifier 212. In response to the low-frequency audio signal SS″, the amplifier 212 amplifies the signal SS″ and drives a low-frequency speaker SP, for example, a woofer or subwoofer, to produce sound according to the low-frequency audio signal SS″. The wireless transmission module 206 and wireless receiving module 210 are compliant with Bluetooth wireless specification, for example.

The above disclosed embodiment of a wireless low-frequency audio system for a television set can reproduce low-frequency sound, even subwoofer sound, according to a low-frequency audio signal, without the need of an expensive audio system. In addition, transmitting a wireless signal representing low-frequency audio to the low-frequency speaker wirelessly makes locating the audio reproduction device 108 more flexible, depending on the users' preferences and without location limitation by audio cables' length as in the conventional approach. In this way, the wireless low-frequency audio system for the electronic device makes the users' living space with the system neat and tidy, meeting the users' need for good-looking living environment.

While the invention has been described by way of examples and in terms of a preferred embodiment and other embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless low-frequency audio system for reproducing sound in response to a source audio signal of an electronic device, the system comprising:
an audio processing device for producing a low-frequency audio signal representing a low-frequency portion of the source audio signal;
a wireless transmission module for wirelessly transmitting the low-frequency audio signal; and
an audio reproduction device, comprising:
a low-frequency speaker;
a wireless receiving module for wirelessly receiving the low-frequency audio signal; and
an amplifier for amplifying the low-frequency audio signal to drive the low-frequency speaker.

2. The system according to claim 1, wherein the wireless transmission module and the wireless receiving module are compliant with Bluetooth wireless specification.

3. The system according to claim 1, wherein the electronic device is a television set.

4. The system according to claim 1, wherein the electronic device is a computer system.

5. The system according to claim 4, wherein the computer system is a notebook computer.

6. The system according to claim 4, wherein the computer system is a desktop computer:

7. The system according to claim 4, wherein the electronic device is a barebone computer system.

8. An audio-video reproduction system, comprising:
an audio processing device, for producing a low-frequency audio signal according to a source audio signal of the audio-video reproduction system;
a Bluetooth transmission module for wirelessly transmitting the low-frequency audio signal; and
a low-frequency speaker;
a Bluetooth receiving module for wirelessly receiving the low-frequency audio signal; and an amplifier for amplifying the low-frequency audio signal to drive the low-frequency speaker.

9. The system according to claim 8, wherein the audio-video reproduction system is a liquid crystal display television system.

10. The system according to claim 8, wherein the audio-video reproduction system is a plasma display television system.

11. The system according to claim 8, wherein audio-video reproduction system is a cathode ray tube television system.
